(19) United States
(12) Patent Application Publication
(10) Pub. No.: US 2016/0332458 A1
(43) Pub. Date: Nov. 17, 2016

(54) A PROPYLENE COMPOSITE BOARD WITH DIGITAL PRINTING & SURFACE COATING

(71) Applicants: Anupam Premchand LUNAVAT, Dubai (AE); ZEP INTERNATIONAL LIMITED, Tortola (VG)

(72) Inventor: Anupam Premchand LUNAVAT, Dubai (AE)

(21) Appl. No.: 15/033,009

(22) PCT Filed: Nov. 3, 2014
(86) PCT No.: PCT/IN2014/000708

§ 371 Date: Apr. 28, 2016

(30) Foreign Application Priority Data
Nov. 1, 2013 (IN) 3488/MUM/2013

(51) Int. Cl. B41J 11/00; B32B 27/08; B32B 27/32; B05D 3/00; B32B 3/12

(52) U.S. Cl. CPC B41J 11/002; B05D 3/007; B32B 3/12; B32B 27/32; B32B 27/08; B32B 2250/242; B32B 2250/05; B32B 2307/584; B32B 2307/3065

(57) ABSTRACT

Natural Marble and Natural Granite, being used in civil construction, are finite resources not perpetually available. There have been attempts to match the attributes of natural marble and granite by artificial processes and at less expense. Though these products closely resemble natural stones, the processes used in manufacturing these articles are slow, and they are difficult to recycle due to the fact that they are made using a combination of different materials. The present invention provides a method for preparing composite board in polypropylene and digitally printing & coating it externally to provide aesthetics and required hardness. The method comprises corona treatment; applying and drying a primer; applying and curing base coat on the dried surface; sanding of the board using fine emery boards; digitally printing and curing the sanded board; application and curing of a primer; and coating and curing to gain surface hardness, abrasion resistance, scratch resistance, fire resistance and gloss.

### FIELD OF INVENTION

The present invention relates to composite boards used in civil engineering applications. More particularly, the present invention relates to a novel light weight composite board with a unique synergistic combination of polypropylene boards having surface digitally printed and coated and method thereof.

### BACKGROUND & PRIOR ART

Natural Marble and Natural Granite are being used in civil construction since ancient times. The combination of beauty, elegance and durability provided by natural marble and granite have not been matched by any other material. But these natural stones are heavy and expensive. They are vulnerable to staining due to their porous nature. Also, Natural Marble and Granite are finite resources not perpetually available.

Attempts have been made in the past to match the attributes of natural marble and granite by artificial processes and at less expense. Marble-like and Granite-like materials obtained, as a result of artificial process, are known as Cultured or Synthetic marbles, Engineered stone and ‘Solid surfaces’ and are manufactured using naturally available and synthetic materials. Some of the materials that are used to manufacture artificial stones are Acrylic resins, Epoxy resins, Unsaturated Polyester resins and Portland cement which are generally used in combination with Alumina Trihydrate (ATH), ground marble or limestone, mica flakes, glass flakes, sand, additives, pigments, and water. Brief descriptions of some of the synthetic ‘Solid surfaces’ and artificial marbles available in the market are given below.

Corian: This solid surface material by DuPont is made from Acrylic polymer and Alumina Trihydrate. It, is primarily used in kitchen countertops, bathroom vanity tops and wall cladding in showers. Due to its non-porous quality, Corian is approved for use in specialized environments, such as laboratories and hospitals.

Polaris, Maxguard, Envirez and Enguard: These unsaturated polyester resins supplied by Ashland Performance Materials are used in the building and construction industry to fabricate solid surfaces, cast marble and artificial Onyx. The fabricated articles possess good hydrolysis resistance, UV stability, stain resistance and fire retardant properties depending upon the formulation.

Sistrom Technology, Moscow have developed a particular process of making artificial marbles and stones using cement, sand and water with pigments and additives. The artificial materials possess good compressive strength and durability and are available in different colors and textures.

Though the artificial stones mentioned above closely resemble natural stones such as Marble and granite, they are heavy and at times fragile, the processes used in manufacturing these articles are slow, and they are difficult to recycle due to the fact that they are made using a combination of different materials. Further, they are not affordable enough for the common man to use them.

The inventor/s of the present invention have attempted to provide a solution to these problems by preparing composite board composed of polypropylene which is lightweight, easy to handle, receptive to printing and can increase the aesthetic value of the product.

Although, digital printing onto a wide variety of substrates including paper, photo paper, canvas, glass, metal or marble, using laser printers or inkjets are commonly known, the technique is, however, hitherto not used for polypropylene substrate.

In view of the above, it is the object to provide cost-effective digital printing method on polypropylene substrates to achieve the desired effects.

### SUMMARY OF INVENTION

The present invention discloses a novel composite board consisting of a polypropylene board with surface printing & coating. The polypropylene board consists of three polypropylene polymer layers extruded separately and bonded simultaneously using thermal energy and plurality of polypropylene (PP) sheets, in a continuous process.

The method of printing and coating on the polypropylene composite board comprises: 1) corona treatment of the board; 2) applying and drying a primer; 3) applying and curing of base coat on the dried surface; 4) sanding of the board using fine emery boards; 5) digitally printing and curing the sanded board; 6) application and curing of a primer; and 7) applying and curing of top coating to gain hardness, abrasion resistance, scratch resistance etc.

The resulting composite board is light weight, yet sufficiently hard and recyclable.

### BRIEF DESCRIPTION

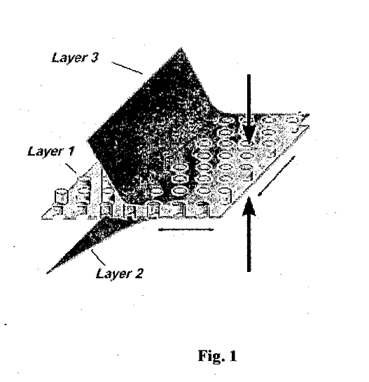

FIG. 1 illustrates base hollow multilayer polypropylene board.

### DETAILED DESCRIPTION

The present invention discloses a cost-effective method for digitally printing and coating thereafter a surface of light weight polypropylene composite board. While understanding the composite board, reference may be made to patent application no. 2538/MUM/2012, by same inventor.

A novel composite board of the present invention consists of at least three layers of polypropylene polymer. The method of printing and coating on the polypropylene composite board comprises corona treatment of the board; applying and drying a primer; application and curing of base coat on the dried surface; sanding of the board using fine emery boards; digitally printing & curing the sanded board; application and curing of another primer; and application and curing of top coating to gain hardness, abrasion resistance, scratch resistance etc.

The preferred method of the present invention is described hereinafter in detail. The surface of articles made of Polypropylene are not easily amenable to be printed by virtue of Polypropylene being naturally hydro-phobic. This is overcome to a certain extent by corona treatment of the surface of the board. The corona treated board is then primed to make the surface receptive to printing. This is achieved by application of a primer using a roller coater. Alternately, the primer can be applied by spraying or curtain coating. The primer is dried thereafter, preferably using infra red lamps. A base coat is subsequently applied and cured on the print-receptive dry surface so obtained. The base coat may be various colors, as per the requirement. The base coating is applied preferably using spray coating. However, the application of base coating is not limited to spray coating.

Once the base coat is dry, the board is sanded using very fine emery boards to obtain a plain level surface. Thereafter, the sanded board surface is digitally printed with the desired design, and cured simultaneously. Another primer is applied and cured, which is followed by coating of the printed surface using specialized coating chemicals and the coating is cured to impart surface hardness, abrasion resistance, scratch resistance, fire resistance and gloss.

The multilayered hollow PP board, being digitally printed and coated according to the method of the present invention, is prepared by hot joining of two plane sheets with a middle layer comprising of equally spaced cylindrical thermoformed structures. The middle layer is produced by casting the sheet on a roller having cylindrical cavities on the surface. A vacuum is created in these cylindrical cavities in order to impart the cylindrical structure to the hot sheet that is cast on this roller. The dimensions of these cylinders can be varied depending upon the thickness and weight of the final board that is required. When the three layers of the board are fused together, air bubbles are formed within the cylindrical cavities of the core (middle layer) since the open ends of the cylinders in the core are closed by the bottom layer of the board. The air-bubbles formed therein reduce the weight of the board and also render extra stability to the board. Each of the three layers described above, in turn consists of three layers each which are produced by means of co-extrusion dies attached to two extruders. In each of the three layers the outer layers are of PP random copolymer having the heat seal initiation temperature in a particular range i.e. around 105° C., and the middle layer is a proprietary mixture of PP homopolymer, PP impact copolymer, filled PP compound and additives to facilitate the process. The thickness of the base board can be varied and depends upon the thickness of the individual layers.

An embodiment, describes the Base Board. The base board provides the body and surface for printing & coating, and comprises of a three layer hollow honey-comb type sandwich construction. All three layers that make the base board are mainly made of Polypropylene (PP) polymers. These are known as the core layer (layer 1), bottom layer (layer 2) and the top layer (layer 3). The structure of the board is illustrated in the FIG. 1.

The composite board of the present invention is distinct by the fact that it consists of single type of plastic material i.e. polypropylene as opposed to the prior arts which use multiple polymeric materials as well as inorganic components. The resulting boards have adequate stiffness, light weight and much better recyclability since they are composed of an all Polypropylene structure. They are manufactured in a fast process and not being very expensive they are affordable to the common man. A distinctive feature of this invention is digital printing on the surface due to which the reproduction of natural marble, granite or any other natural or manmade design is possible. The special digitally printed image so formed on the surface of the board is further coated to impart surface hardness, scratch resistance and gloss. The finished board can also be backlit using different coloured lights to obtain beautiful effects.

The digitally printed and coated polypropylene composite board according to the present invention can be used in various fields such as civil engineering. Uses in civil engineering include wall paneling, cladding, flooring, etc. in different shapes. Other uses include panels for advertisements, point of purchases (POP) display, furniture etc.

The aforementioned description is for the illustrative purpose only and not intended to limit the scope of the invention to the embodiments. The variations and modifications of the present invention are obvious to the person skilled in the art in light of the above teachings.

1. A method for printing and coating a polypropylene composite board comprises:
a) corona treatment of a surface of said board;
b) applying and drying a primer to produce a dried surface;
c) applying and curing a base coat on the dried surface;
d) sanding the board;
e) printing an image on the sanded board and curing the printed image
f) applying and curing a primer; and
g) applying and curing a top coating on the surface of said board for providing at least one of hardness, abrasion resistance, scratch resistance, fire resistance and gloss.

2. The method claimed in claim 1, wherein said polypropylene composite board comprises a three layer polypropylene (PP) based hollow honey-comb type core and a plurality of polypropylene (PP) sheets sandwiching said honey-comb type core.

3. The method claimed in claim 2, wherein said polypropylene sheets are self-reinforced.

4. A polypropylene composite board comprising a three layer polypropylene (PP) based hollow honey-comb type core sandwiched between two polypropylene (PP) sheets.

5. (canceled)

6. The method claimed in claim 1, wherein corona treatment of the surface of said board makes the surface receptive to printing.

7. The method claimed in claim 1, wherein printing an image on the sanded board comprises a step of digitally printing said image.

8. The polypropylene composite board claimed in claim 4, wherein a surface of said polypropylene composite board is a print-receptive corona treated surface.

9. The polypropylene composite board claimed in claim 8, wherein said surface of said polypropylene composite board has a printed image thereon, and comprises at least one primer layer, at least one base coat, and a top coating.

10. A construction material comprising a polypropylene composite board as claimed in claim 4.

11. An advertising display comprising a polypropylene composite board as claimed in claim 4.
